(19) United States
(12) Patent Application Publication
(10) Pub. No.: US 2016/0367994 A1
(43) Pub. Date: Dec. 22, 2016

(54) Segmented Roller and Method of Reconditioning Same

(71) Applicant: Cast Steel Products LP, By Its General Partner Cast Steel Products GP Ltd., Edmonton, CA (US)

(72) Inventors: Dustin Birtch, Edmonton (CA); John McIntyre, Edmonton (CA); Nick Meeboer, Edmonton (CA)

(73) Assignee: Cast Steel Products LP, By Its General Partner Cast Steel Products GP Ltd.

(21) Appl. No.: 15/190,901

(22) Filed: Jun. 23, 2016

Related U.S. Application Data
(63) Continuation of application No. PCT/CA2015/050119, filed on Feb. 18, 2015.
(60) Provisional application No. 61/941,856, filed on Feb. 19, 2014.
(60) Provisional application No. 62/076,117, filed on Nov. 6, 2014.

(51) Int. Cl. B02C 4/30

(52) U.S. Cl. CPC B02C 4/305; B02C 2210/02

(57) ABSTRACT

A roller surface reinforcement system and a method of reconditioning a roller is provided. A plurality of surface segments are fastened to a hub. In some embodiments, an engagement structure is provided to maintain a gap between adjacent surface segments to reduce wear. The surface segments can be provided with studs, teeth, depressions, blades, grooves, paddles, or the like. When the roller is worn out, the plurality of surface segments can be removed and replaced with new surface segments, so as to create a reconditioned roller surface.

### RELATED APPLICATION

This application is a continuation of International App. No. PCT/CA2015/050119 entitled “SEGMENTED ROLLER AND METHOD OF RECONDITIONING SAME” filed on Feb. 18, 2015; which claims priority on U.S. App. No. 61/941,856 entitled “ROLLER WITH REPLACEABLE SURFACE SEGMENTS AND METHOD OF RECONDITIONING SAME” filed on Feb. 19, 2014; and U.S. App. No. 62/076,117 entitled “SEGMENTED ROLLER AND METHOD OF RECONDITIONING SAME” filed on Nov. 6, 2014, all of which are herein incorporated by reference in their entirety.

### TECHNICAL FIELD

The present invention relates to rollers and grinders for industrial use, including mining, trash compaction and other uses. In particular, the invention relates to surface reinforcements for rollers subjected to wear conditions and methods of replacing same, in which the surface reinforcement is replaceable to allow reconditioning of worn rollers.

### BACKGROUND

Friction-based rollers are common components of many machines. A frequent problem with such rollers is wear on the roller surface over time, particularly if the roller is subjected to large frictional forces. When the surface of the roller begins to wear out or becomes uneven, the roller must then be replaced or the surface of the roller must be remanufactured.

Frictional wear is particularly problematic for industrial rollers used to crush, compact, shred, or grind materials. Industrial rollers are used extensively in mining operations to break up rock, ore, and other brittle materials into smaller particles. Industrial rollers can also be used for trash compaction or in other applications where high throughput crushing, shredding, or compaction is required. Two basic types of industrial rollers are commonly used; the first being a single roller operating adjacent to a stationary curved anvil plate and the second being a double counter-rotating set of rollers having parallel axes and a gap between the rollers.

Particle output size from a roller or pair of rollers is determined by the size of the gap, also known as the ‘nip’, between the roller surface and the opposing surface, such as an anvil plate or opposing roller. Material is drawn into the nip by the rotating motion of the roller surface and exits the nip in a continuing stream of crushed, compacted, or shredded material.

In many industrial applications, particularly in the mining industry, industrial rollers are subjected to extremely high pressures and/or are used to crush relatively hard materials, both of which can result in significant frictional wear on the rollers. A common symptom of such wear is known as ‘dishing’, in which the surface of the roller develops a concave profile over time. Alternatively, when one or both ends of the roller are subjected to greater wear than the center of the roller, the roller surface can also develop a conical or convex profile over time. The resulting unevenness in the roller surface can be problematic as it increases the effective size of the nip across the axial length of the roller and the particulate size of the material output by the roller increases accordingly.

One conventional approach to extending the life of an industrial roller is to reinforce the working surface of the roller with extremely hard materials, such as tungsten carbide. Nevertheless, even the hardest materials will wear out over time and so this approach can only extend the time required before the roller must be replaced or remanufactured in order to provide an even surface.

Industrial rollers also often have surface features such as teeth, blades, or studs that assist the working surface of the roller to direct material into the nip and also to assist with the crushing or shredding action of the roller. Depressions or grooves on the roller surface can also be used to retain milled material on the roller surface, as a means of reducing wear on the roller surface. However, like the roller surface itself, surface features also wear out over time due to friction, even if they are constructed from relatively hard materials.

Conventional crushing rollers used in the mining industry use an array of tungsten carbide studs as a surface reinforcement. The carbide studs are inserted into a plurality of holes distributed across the surface of the roller and the studs are typically welded in place. In operation, the studs act as teeth to assist in the grinding action and the spaces between the studs retain milled material and so protect the underlying roller surface from wear. Over time, the studs wear out, often in an uneven manner, and the underlying roller surface can also be subjected to uneven wear.

When an industrial roller reaches the end of its service life, it must be replaced or remanufactured. In many applications, particularly in the mining industry, industrial rollers can be quite large and so remanufacture is often preferred over complete replacement of the roller.

The remanufacture of a worn roller is not a simple or inexpensive task. This usually involves removal of the entire drum from service, followed by extensive cutting, machining, and re-welding of the surface of the drum.

For rollers in the mining industry that rely on carbide studs, it is not uncommon to cut off the studs using a lathe followed by installing new studs on the roller surface. For example, U.S. Pat. No. 8,316,543 to Patzelt et al. describes one process in which the surface of the roller is machined and the reconditioned surface is built back up using a welding process to deposit new surface material. New holes are then drilled in the rebuilt surface and new studs are set into place. U.S. Patent Application No. 2012/0138722 A1 by Brendler describes a similar approach, in which surface features on the worn roller are cut off, a groove is machined into the reconditioned roller surface, new features are set into either side of the groove, and a form fitting body is inserted between the features to fill in the machined groove and hold the features in place.

Methods which rely on turning or machining an industrial roller will generally result in a reduction in the diameter of the remanufactured roller, unless new material is welded onto the surface to replace the material lost during the reconditioning process. For industrial rollers which employ studs, conventional methods require a new array of receiving holes to be drilled on the roller surface.

Regardless of the method used during remanufacture, the need for secure attachment of the surface reinforcements to the roller drum and the reliance in the art on welding for attaching features to the roller surface makes remanufacture of worn out rollers difficult, expensive, and labour intensive.

### SUMMARY OF THE INVENTION

According to one broad aspect, the invention provides a rotatable hub having a working surface that comprises a plurality of replaceable surface segments. These segments can be removed and replaced to recondition the working surface of the roller. The surface segments are fastened to a central hub at engagement structures that attach the surface segments to the hub but which also permits the segments to be removed from the hub for reconditioning.

Each surface segment has an outer surface which forms a portion of the working surface of the assembled roller. Collectively, the surface segments may form all or substantially all of the working surface of the assembled roller. In some embodiments, each surface segment extends along the entire length of the roller assembly. In other embodiments, there may be several surface segments along the length of the roller, preferably arranged in rows and/or geometric patterns. In such embodiments, it may be preferable to stagger surface segments in adjacent rows to extend the life of the roller assembly. It may also be preferable to arrange the surface segments so that they meet at an oblique angle relative to the direction of rotation.

In some embodiments the surface segments are directly fastened to the hub using bolts or the like. In other embodiments, the engagement structures are channels or projections which form an interlocking relationship and surface segments are slid into place from an end face of the hub, with retention structures used to secure the segments against movement along the engagement structures. In some embodiments, the retention structures may be plates that attach to the end face of the hub and engage the surface segments to prevent their exit from the channel or projection. In further embodiments, the retention structures may be members (such as edge reinforcements) which slidably engage the end face of the hub and block the exit of the surface segments from the channel or projection. In still further embodiments, the outermost surface segments in a row are directly fastened to the hub, thereby holding the surface segments therebetween in place.

The outer surface of the surface segments may also include surface features, such as studs, teeth, depressions, grooves, paddles, or blades. For example, surface features may comprise tungsten carbide pins affixed in holes provided in the surface segments or integral with the surface segment itself. Other known surface features can also be provided on the surface segments, depending on the application for the roller. Replacement of the surface segments thus results in the replacement of these surface features.

The hub mounts to a shaft driven by a motor or other drive mechanism. The hub may be removed from the shaft for reconditioning or for other purposes. The drive mechanism may comprise a mechanical, electrical, pneumatic, or other suitable actuator for rotating the shaft. The shaft may comprise a cylindrical portion for mounting the hub and at least one axle for supporting and/or driving the roller. The shaft may further comprise an annular flange at one end thereof to align the hub on the shaft.

Surface segments may be removed from the hub and replaced without removing the hub from the shaft. Alternatively, the hub may be removed from the shaft for replacement of all or some of the segments, thereby permitting quick replacement of the roller assembly while the worn roller is being reconditioned. Segments can be replaced individually to correct localized defects in the outer surface of the roll, or replaced en masse to recondition all or substantially all of the working surface of the roll.

The surface segments may be attached to the hub with gaps between adjacent segments, which may provide reduced edge wear. Such gaps may be provided by configuring the engagement structure on the hub and/or the surface segment with dimensions that generate these gaps when the segments are mounted on the hub. Alternatively, or in addition, the gaps may be provided by an alignment member, which aligns the surface segments on the hub in such a manner so as to provide the necessary gap. To prevent fouling of the gap with dirt or milled, crushed, or rolled material, the gap may be small in size, such as less than 1 mm, or about 0.25 mm.

The invention further relates to individual surface segments, hubs, and retention structures as described above, which may be provided in the form of a kit, for creation of a roller assembly as described above.

The invention also provides a method for reconditioning a roller, comprising removing one or more surface segments from an outer surface of the hub of the roller and fastening new surface segments to the hub of the roller. The method may further comprise the step of aligning the new surface segments on the hub of the roller, prior to fastening, so as to create a gap between the adjacent surface segments. In some embodiments, the method further includes removing a retention structure and sliding the worn surface segments off the end of the hub. New surface segments are then slid into place and the retention structure is used to secure a row of surface segments.

In one aspect, there is provided a roller assembly having a working surface for crushing, grinding, or otherwise contacting a material, the roller assembly comprising a hub configured for mounting to a shaft, said hub rotating about a central axis and having two opposing faces, a length parallel to the central axis, and an exterior surface; one or more engagement structures disposed on the exterior surface of the hub, preferably along the length of the hub; and a plurality of replaceable surface segments configured for releasably attaching to said one or more engagement structures, each of the plurality of surface segments having an inner surface configured to engage at least one engagement structure and an outer surface opposed to the inner surface; wherein the working surface comprises the outer surface of at least one of the plurality of surface segments.

In some embodiments, the engagement structures situate the surface segments at predetermined positions on the exterior surface of the hub, preferably so as to provide a gap between the outer surfaces of adjacent surface segments, preferably less than 1 mm or less than 0.25 mm.

In some embodiments, the engagement structures are arranged in rows, substantially parallel to the central axis of the roller. The exterior surface of the hub may in some cases be multi-faceted, with the outer surface of the hub being polygonal in cross section.

In some embodiments, the plurality of surface segments are releasably attached to the hub using a fastener, such as a bolt. Alternatively, or in addition, the inner surface of the plurality of surface segments may slidably engage the engagement structures. In some cases, the engagement structures include a plurality of projections (such as ridges, preferably substantially parallel to the central axis and/or extending along the length of the hub) and the inner surface of the plurality of surface segments comprises a corresponding depression, preferably for forming an interlocking relationship therewith. In other cases, the engagement structures on the exterior surface of the hub comprise a plurality of channels (preferably substantially parallel to the central axis and extending along the length of the hub) and the inner surface of the plurality of surface segments comprises a corresponding projection, preferably for forming an interlocking relationship therewith. In some instances, the interlocking relationship is mediated by a dovetail profile, a T-shape profile, ball and socket profile, head and stalk profile, or a U-shaped dovetail profile.

In some embodiments, the projections or channels on each of the inner surfaces of the plurality of surface segments are between about one-quarter to one-half the width of the surface segment, preferably about one third the width of the surface segment. In other cases, the projections or channels on each of the inner surfaces of the plurality of surface segments are greater than one-half the surface segment, preferably about two thirds or three quarters the width of the surface segment.

In some embodiments, the roller assembly further includes a removable retention structure for preventing movement of the plurality of surface segments relative to at least one of the engagement structures. In some cases, the retention structure is an annular plate disposed on at least one of the opposing faces of the hub, the annular plate engaging at least one of the plurality of surface segments to prevent movement thereof. In other cases, the retention structure is an edge reinforcement which engages at least one of the opposing faces of the hub; or a retainer plate fastened to at least one of the opposing faces of the hub; preferably by sliding engagement, the edge reinforcement also engaging at least one of the plurality of surface segments to prevent movement thereof. In such cases, the slidable engagement of the retention structure may be mediated by a mortise and tenon relationship, preferably a dovetail, and more preferably a U-shaped dovetail. In still further cases the retention structure may be a bolt which fastens at least one surface segment to the hub at a position proximate to at least one opposing face of the hub.

In some embodiments, the outer surfaces of the plurality of surface segments are arcuate in cross section and the inner surfaces of the plurality of surface segments are substantially planar. In further embodiments, the outer surfaces of the plurality of surface segments form greater than 80%, greater than 90%, greater than 95%, or substantially all of the working surface. In some examples of the invention, the surface segments may be substantially square, rectangular, triangular, parallelogram-shaped, or a combination thereof, preferably in a repeating geometric pattern.

In some embodiments, the plurality of surface segments are arranged on the outer surface of the hub in at least two adjacent rows extending between the opposing faces of the hub; and one or more surface segments in the first adjacent row are staggered with respect to one or more surface segments in the second adjacent row. In still further embodiments, at least two of the plurality of surface segments are arranged on the outer surface of the hub in at least one row extending between the opposing faces of the hub; and two or more adjacent surface segments in the at least one row meet at an oblique angle relative to the direction of rotation, preferably less than 90 degrees, less than 60 degrees, or between 55 and 45 degrees.

In some embodiments, at least one of the outer surfaces of the plurality of surface segments include surface features, preferably studs, teeth, depressions, grooves, paddles, blades, or a combination thereof. Two or more of the plurality of surface segments may also cooperate to provide a single surface feature.

In some embodiments, the hub may comprise an inner layer configured for mounting to the shaft and an outer layer comprising the exterior surface upon which the engagement structures are disposed.

In another broad aspect, the invention includes a method of reconditioning a roller assembly. The method includes, removing one or more worn surface segments from an outer surface of a hub of the roller, the hub rotatable about a central axis; engaging an inner surface of one or more replacement surface segments with an engagement structure disposed on the outer surface of the hub; and securing the one or more replacement surface segments to the outer surface of the roller.

In some embodiments, the method further includes the step of aligning the one or more replacement surface segments on the engagement structure, so as to create a predetermined gap between adjacent surface segments.

In some embodiments, the engagement structures are channels or ridges which extend to a peripheral edge of the hub and the inner surface of the plurality of surface segments slidably engage the engagement structures; and the step of removing one or more worn surface segments from an outer surface of a hub of the roller comprises removing a retention structure from the roller assembly so as to permit the one or more worn surface segments to be moved along the engagement structure, and sliding the worn surface segment along the engagement structure to the peripheral edge of the hub; and the step of securing the one or more replacement surface segments comprises replacing the retention structure so as to prevent the one or more worn surface segments to be moved along the engagement structure.

In some embodiments, the retention structure comprises an annular plate connected to an end face of the hub, at the intersection of the engagement structure and the peripheral edge of the hub; and the step of removing the retention structure comprises disconnecting the annular plate from the peripheral edge of the hub.

In some embodiments, the retention structure comprises an edge reinforcement slidably engaged with an end face of the hub or a retainer plate fastened to an end face of the hub, at the intersection of the engagement structure and the peripheral edge of the hub; and the step of removing the retention structure comprises sliding the edge reinforcement away from the hub.

In some embodiments, the step of securing the one or more replacement surface segments comprises fastening the replacement surface segment to the hub. For example, the retention structure may comprise a bolt which fastens at least one surface segment to the hub at the peripheral edge thereof; and the step of removing the retention structure comprises removing the bolt.

In some embodiments, the step of engaging the inner surface of one or more replacement surface segments comprises aligning a first interlocking feature on the inner surface of the one more replacement surface segments with a second interlocking feature on the engagement structure. In some cases, the replacement surface segments comprise surface features, preferably studs, teeth, depressions, grooves, paddles, blades or a combination thereof.

In some embodiments, the method further includes heating one or more portions of the roller assembly to destroy any glue applied thereto. In further embodiments, the hub comprises an inner layer configured for mounting to a shaft and an outer layer comprising the exterior surface upon which the engagement structures are disposed; and the method comprises the further step of replacing the outer layer of the hub before securing the one or more replacement surface segments.

Directional terms such as “front” and “rear”, “top” and “bottom”, “first” and “second”, “right” and “left” are used herein purely for convenience of description. Such terms are used for illustration purposes and are not intended to limit the present disclosure. As well, and dimensions herein are not intended to limit the scope of the invention unless specifically stated. Furthermore, geometric terms such as “straight”, “flat”, “point” and the like are not intended to limit the invention to the level of geometric precision, but should instead be understood in the context of the invention which includes such departures from geometric position as the manufacturing tolerances that are normal and/or acceptable in the field of this invention, as well as the functional requirements of products in the field of the invention wherein a high level of precision may not be required.

### BRIEF DESCRIPTION OF THE DRAWINGS

FIG. 1 is a perspective view of a roller assembly according to one embodiment of the present invention.

FIGS. 2A-2C are perspective views of the shaft (FIG. 2A), hub (FIG. 2B), and surface segment (FIG. 2C) of the reinforced roller shown in FIG. 1.

FIG. 3A is a perspective view of the shaft of FIG. 2A mated to the hub of FIG. 2B.

FIG. 3B is a perspective view of the surface segment of FIG. 2C fastened to the shaft and hub of FIG. 3A.

FIG. 4 is an enlarged perspective view of the junction between two surface segments of the reinforced roller of FIG. 1.

FIGS. 5A-5C depict a roller assembly according to a further embodiment of the present invention in perspective view (FIG. 5A), side view (FIG. 5B), and top view (FIG. 5C).

FIG. 6 is a perspective view of the roller assembly of FIGS. 5A-5C, in a partially disassembled state.

FIGS. 7A-7C are enlarged perspective views of the partially disassembled roller assembly of FIG. 6.

FIGS. 8A-8I depict the hub (FIG. 8A), retention structure (FIG. 8B), first surface segment (FIGS. 8C-8E), second surface segment (FIGS. 8F-8H), and edge protector (FIG. 8I) of the roller assembly of FIGS. 5A-5C.

FIG. 9 is a perspective view of a roller assembly according to yet another embodiment of the present invention.

FIGS. 10A-10C depict the roller assembly of FIG. 9 in various states of disassembly, in perspective view (FIGS. 10A, 10C) and side view (FIG. 10B).

FIGS. 11A-11D depict the retention structure of the roller assembly of FIG. 9, in perspective view (FIG. 11A), front view (FIG. 11B), side view (FIG. 11C), and end view (FIG. 11D).

FIGS. 12A-12D depict the first surface segment of the roller assembly of FIG. 9, in perspective view (FIG. 12A), top view (FIG. 12B), side view (FIG. 12C), and end view (FIG. 12D).

FIGS. 12E-12H depict the second surface segment of the roller assembly of FIG. 9, in perspective view (FIG. 12E), top view (FIG. 12F), side view (FIG. 12G), and end view (FIG. 12H).

FIGS. 12I-12L depict the third surface segment of the roller assembly of FIG. 9, in perspective view (FIG. 12I), top view (FIG. 12J), side view (FIG. 12K), and end view (FIG. 12L).

FIGS. 13A-F depict the hub of the roller assembly of FIG. 9, in perspective view (FIG. 13A), in enlarged side view partly broken away (FIG. 13B), in enlarged top view partly broken away (FIG. 13C), in detailed scrap view of area “A” in FIG. 13C (FIG. 13D), in cross-section through line C-C of FIG. 13C (FIG. 13E), and in cross section through line B-B of FIG. 13B (FIG. 13F).

### DETAILED DESCRIPTION

With reference to the above drawings, various examples will be now be disclosed which illustrate, by way of example only, various embodiments of the invention contemplated herein.

### Example 1

### Roller Assembly with Bolt-on Surface Segments

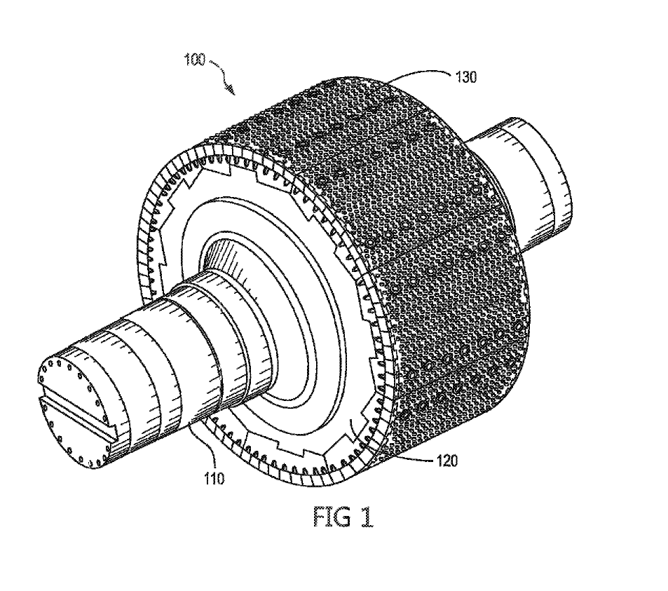

FIG. 1 provides a roller assembly 100 in accordance with one embodiment of the present invention. In this embodiment, the roller assembly 100 is in general terms a rotatable cylindrical member with a working surface for grinding, shredding, rolling, or other uses. In this embodiment, the roller assembly 100 has a central hub 120 for mounting to a shaft 110, in this case at a central aperture 122. In other embodiments, the hub 120 may be solid and the shaft can connect to one or both opposing faces 124 of the hub 120. The hub 120 has an outer surface 125 to which a plurality of surface segments 130, 134 are mounted. The surface segments 130, 134 form some or all of the working surface of the roller assembly 100.

In this embodiment, the roller assembly 100 can be mounted on a shaft 110 which passes through the aperture 122 in the hub 120, such that rotation of the shaft 110 drives the roller assembly 100. In other embodiments, the shaft 110 can connect to one or both of the opposing faces 124 of the hub 120, rather than passing through a central aperture 122.

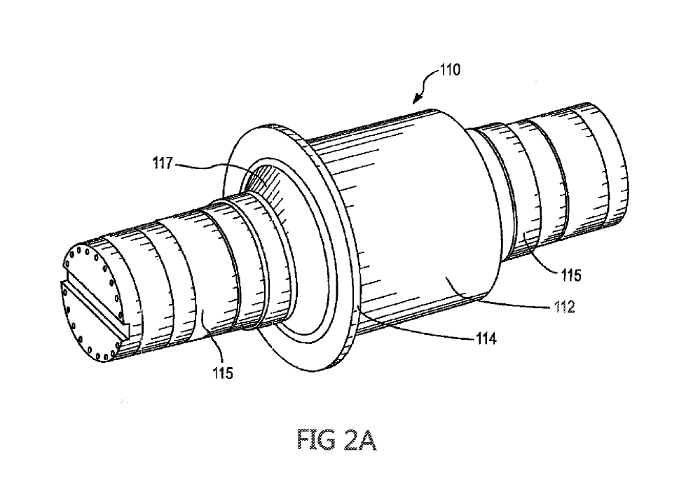

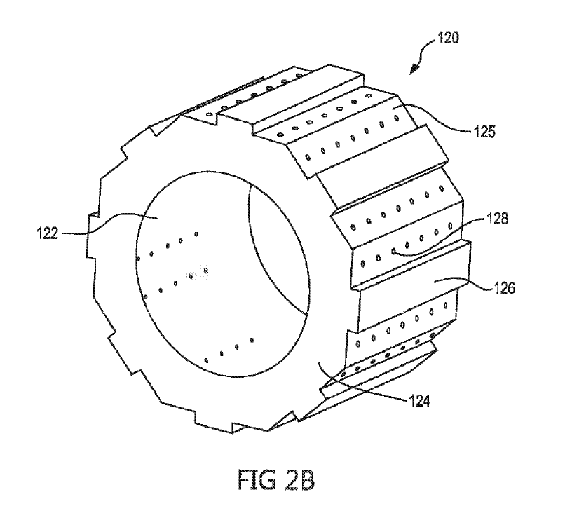

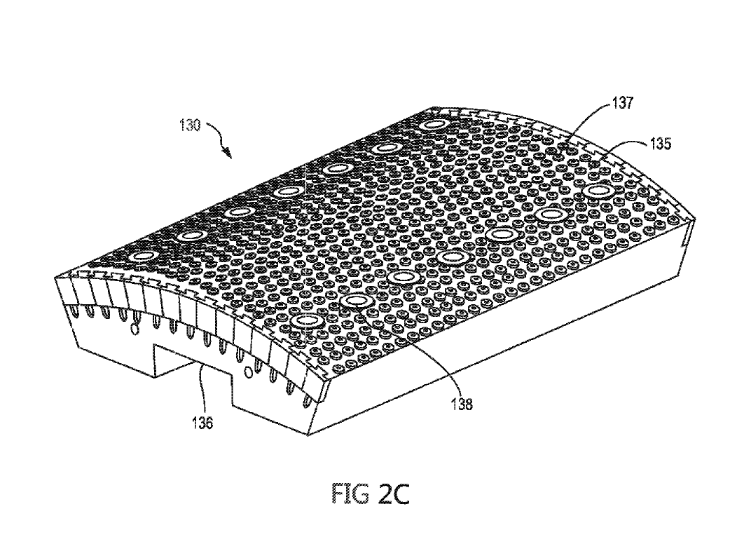

FIG. 2A provides an isolated view of the shaft 110 shown in FIG. 1. In this embodiment, the shaft 110 has a cylindrical region 112 upon which the hub 120 is installed. More specifically, cylindrical region 112 passes through the central aperture 122 of the hub 120 and is securely fastened thereto in a non-rotatable manner, whereby torque is transferred from the shaft 110 to the hub 120. Attachment of hub 120 to the shaft 110 may be provided by any suitable structure or technique known in the art, such as shrink fitting of the hub 120 onto the shaft 110 by the application of heat. FIG. 3A depicts the hub 120 in FIG. 1 mounted onto the shaft 110 of FIG. 2A.

The shaft 110 shown in FIG. 2A further comprises an annular flange 114 which positions the hub 120 in its correct position on the shaft 110 during the installation process. In this embodiment, at least one axle 115 protrudes at one or both ends of the shaft 110. Axle(s) 115 may be rotatably journalled within an axle support (not shown) to support the roller 100 and/or linked to a drive mechanism (not shown) for rotatable driving of the roller 100. The junction between the axle(s) 115 and the cylindrical region 112 comprises a collar 117, which provides additional structural support and transmits forces between the cylindrical region 112 and axle(s) 115.

The shaft 110 can be rotatably driven by any drive or drive mechanism (not shown) known in the art suitable for driving a roller assembly 100 of the type disclosed herein. Further mechanical components may also be provided as appropriate, such as a gearbox, emergency disconnect and other known components, not shown but conventional.

FIG. 2B depicts the hub 120 of FIG. 1 in isolation. The configuration and dimensions of the hub 120 can be sized as appropriate for a selected application of the roller 100. Hub 120 may be fabricated from steel or other lower-cost materials, in particular since hub 120 is less exposed to wear than surface segments 130 and need not be fabricated from a highly wear-resistant (and normally more costly) material.

In the example embodiment shown in FIG. 2B, the outer surface 125 of the hub 120 is comprised of a series of planar facets. The resulting hub 120 is thereby provided with a polygonal cross-section. The number of facets can be adjusted depending on the number of surface segments 130 to be used in the roll assembly 100. Each facet features an engagement structure 126, which in this case is a projection in the form of a rectangular prism.

FIG. 2C depicts a surface segment 130 in isolation. Here, the surface segments 130 are configured with an inner surface that is essentially planar, so as to simplify the construction of the surface segments 130. An arcuate outer surface 135 of the surface segment 130 allows for the formation of an essentially cylindrical working surface for the roller 100.

In this example embodiment, the outer surface 135 of the surface segment 130 is provided with surface features 137, in this case carbide studs, which protrude from the outer surface 135 of the surface segment 130. A variety of surface features 137 are contemplated depending on the application of the roller 100, such as teeth, grooves, dimples, ridges, and other structures. Alternatively, the surface segments 130 may lack surface features 137 entirely and the outer surface 135 of the surface segment 130 itself may be comprised of a hardened material which resists wear, such as tungsten carbide or harder grades of steel.

The surface segments 130 and the hub 120 are releasably engaged with one another at engagement structures 126, 136. In the embodiment shown in FIGS. 2B-2C, the engagement structure 126 on the outer surface 125 of the hub 120 is provided as a male member, in this case a rectangular projection. This engagement structure 126 interlocks with a corresponding engagement structure 136, in this case a female member formed as a rectangular channel, on the underside of surface segment 130. In this embodiment, the engagement structure 126 on the hub 120 projects radially outwards and extends along the axial length of the roller 100, substantially parallel to its rotational axis. This engagement structure 126 is received by the corresponding engagement structure 136 on the inner surface of the surface segment 130, thereby providing stability to the surface segment 130 when the roller 100 is in motion, particularly with regard to torsional forces.

Although the engagement structures 126, 136 shown in FIGS. 2B and 2C extend across the length of the roller assembly 100, other lengths are also contemplated. For example, engagement structures 126, 136 that extend for less than the full length of the roller assembly 100 and/or engagement structures 126, 136 comprising multiple male and female members arranged along the length of the roller 100 are also contemplated.

In FIG. 2C, the engagement structure 136 on the surface segment 130 is approximately one-third the width of the surface segment 130 and/or one-third the width of the facet on the outer surface 125 of the hub 120. Various other widths are also contemplated for the engagement structures 126, 136, such as one quarter to one half the width of the surface segment or facet. As discussed below, wider arrangements may also be possible, such that the width of the engagement structure 136 is between two-thirds and three-quarters of the width of the surface segment 130, or greater.

The embodiment shown in FIGS. 2B-2C feature engagement structures 126, 136 having a mortise and tenon relationship. As discussed below, mortise and tenon arrangements having interlocking profiles are also contemplated, including dovetailed, T-shaped, head and stalk, or similar interlocking profiles which limit movement of the surface segment 130 in the radial direction. Similarly, arrangements in which a male member is provided as the engagement structure 136 on the surface segment 130 and a female member is provided as the engagement structure 126 on the hub 120 are also contemplated.

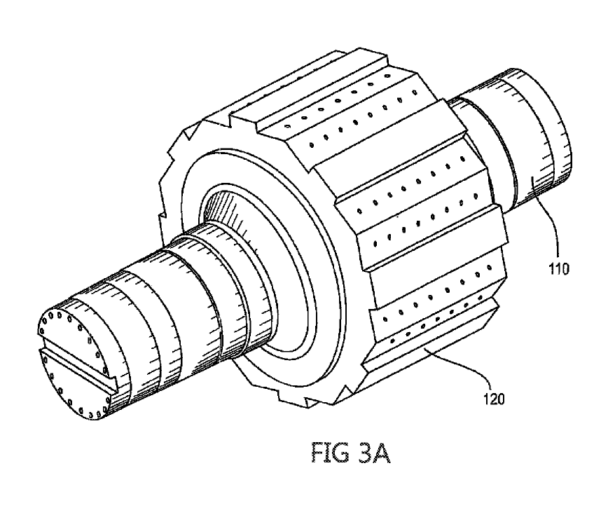

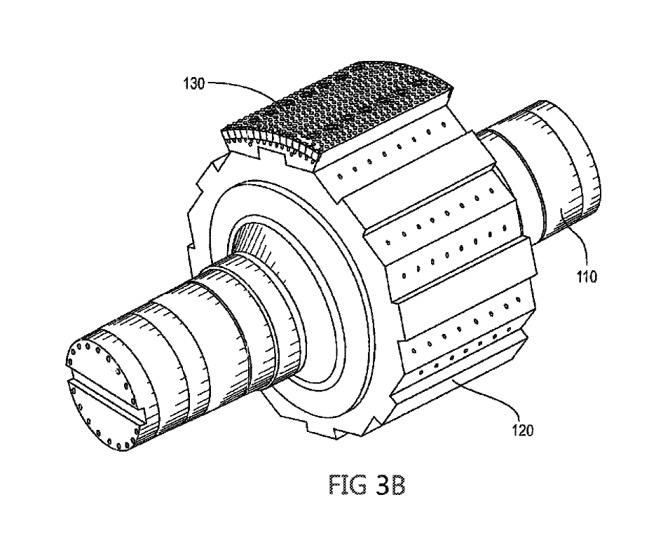

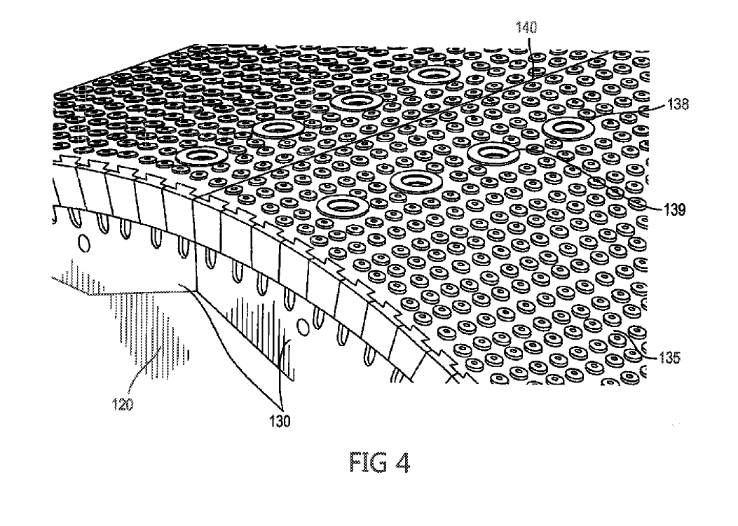

FIG. 3B depicts the hub 120 of FIG. 2B fastened to the surface segment 130 of FIG. 2C. In this example, and as seen in FIG. 4, the engagement between the male and female members at the engagement structures 126, 136 is secured by a bolt 139, which passes through a bolt hole 138 in the surface segment 130 and secures into a corresponding threaded bolt hole 128 in the outer surface 125 of the hub 120. Various other means of releaseable fastening known in the art are also contemplated, such as heat releasable glues, metal screws, heat shrinking and the like. Likewise, although FIG. 3B depicts fastening of the surface segments 130 in a radial direction, fastening is also contemplated in an axial direction, particularly where the engagement structures interlock using a profile which prevents movement in the radial direction.

When assembled, the hub 120 of the roller assembly 100 in FIG. 1 is surrounded by a plurality of surface segments 130. In some embodiments, the outer surfaces 135 of the plurality of surface segments 130 make up greater than 80%, 90%, or 95% of the working surface of the roller assembly 100. In other embodiments, such as the roller assembly 100 in FIG. 1, the outer surfaces 135 make up all or substantially all of the working surface of the roller assembly 100.

The number and radial arrangement of the surface segments 130 will depend on the radius of the roller 100 and/or the width of the surface segments 130. Surface segments 130 may also extend along the full length of the roller 100 or be arranged in geometric patterns such that more than one surface segment 130 is present along the axial length of the outer surface 125 of the hub 120.

Referring to FIG. 4, the surface segments 130 of the embodiment shown therein meet at a gap 140, which provides a separation between adjacent surface segments 130, which prevents adjacent surface segments 130 from directly contacting one another. The presence of a gap 140 may, in some applications, reduce premature wear of the surface segments 130, which might otherwise rub against one another. The size of the gap 140 required depends on a number of factors, including the material being crushed, shredded, or milled by the roller assembly 100. In some applications, the gap 140 is small, such as less than 5 mm, less than 1 mm, or about 0.25 mm. In other applications, the gap 140 may be larger, particularly in applications where the entry of milled material into the gap 140 would not be considered problematic for the operation of the roller 100.

In operation, a roller assembly 100 according to the embodiment shown in FIGS. 1-4 may be used in the conventional manner. For example, the roller assembly 100 may be positioned opposite to a fixed anvil (not shown) or an opposing counter-rotating roller (not shown) to crush, compact, or shred materials fed to the roller 100. In some embodiments, the counter-rotating roller is also reinforced according to the present invention. Material fed into the roller enters the nip, where the surface segments 130, either alone or in combination with surface features 137, crush, shred, or compact material as it passes through the nip.

When the roller assembly 100 in FIGS. 1-4 reaches the end of its lifespan, it can be reconditioned by replacing one or more worn surface segments 130 on the hub 120 with new surface segments 130. The replacement of one or more surface segments 130 in turn provides a new working surface for the roller assembly 100. Replacement of surface segments 130 rather than the entire roller assembly 100 also allows for reconditioning without the need to remove the roller assembly 100 from the shaft 110.

If the surface segments 130 are bolted in place, the surface segments 130 may be removed by extracting the bolts 139 from the bolt holes 123, 138. If the surface segments 130 are glued in place or shrink-fit, the roller 100 or the segments 130 being removed may be heated to a sufficiently high temperature to destroy the glue or release the shrink-fitting. In any event, hammering may also be required to free the surface segments 130, particularly if the roller 100 has been fouled with dirt or ground material during its operation.

If the surface segments 130 also carry surface features 137 such as studs, teeth, depressions, grooves, paddles, or blades, the replacement of the surface segments 130 also results in the replacement of the surface features 137 on the roller 100. Accordingly, the remanufacture process can also be used when the surface features 137 are worn, before the underlying surface segments 130 which carry them also become worn.

### Example 2

### Segmented Roller with Slide-on Surface Segments

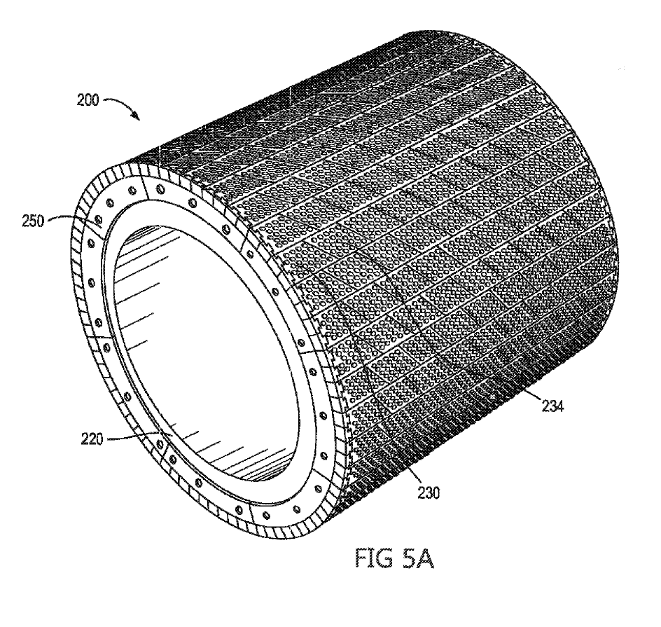

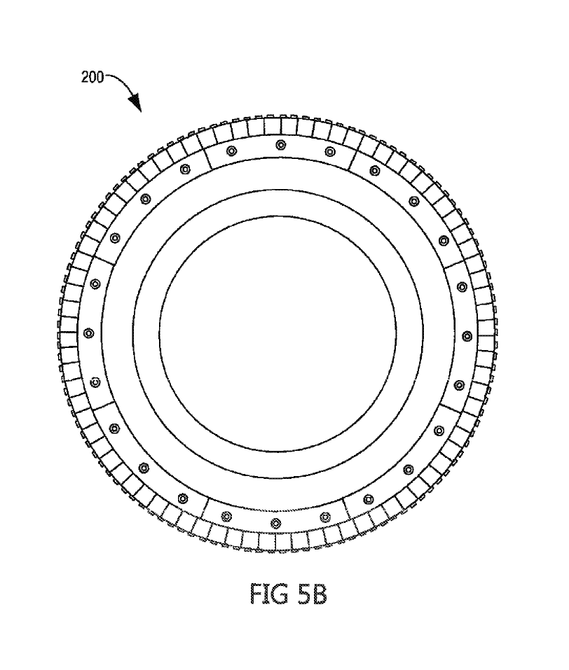

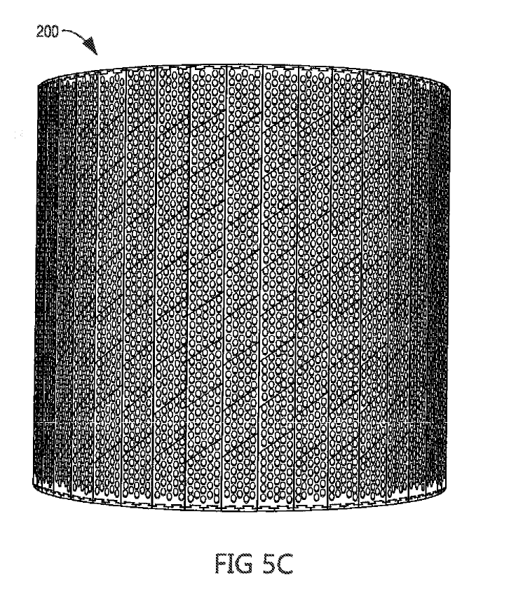

FIGS. 5A-5C provides a roller assembly 200 in accordance with another embodiment of the present invention.

As with the previous example embodiment, the roller assembly 200 is in general terms a rotatable cylindrical member with a working surface for grinding, shredding, rolling, or other uses. In this embodiment, the roller assembly 200 has a central hub 220 for mounting to a shaft 110, in this case at a central aperture 222 in the manner described for roller assembly 100 above. The hub 220 has an outer surface 225 to which a plurality of surface segments 230, 234 are mounted. The surface segments 230, 234 form some or all of the working surface of the roller assembly 200. These features have similar function to the corresponding features discussed above for roller assembly 100 and so similar reference numerals in the ‘200’ series have been used to illustrate features having similar functions in this embodiment.

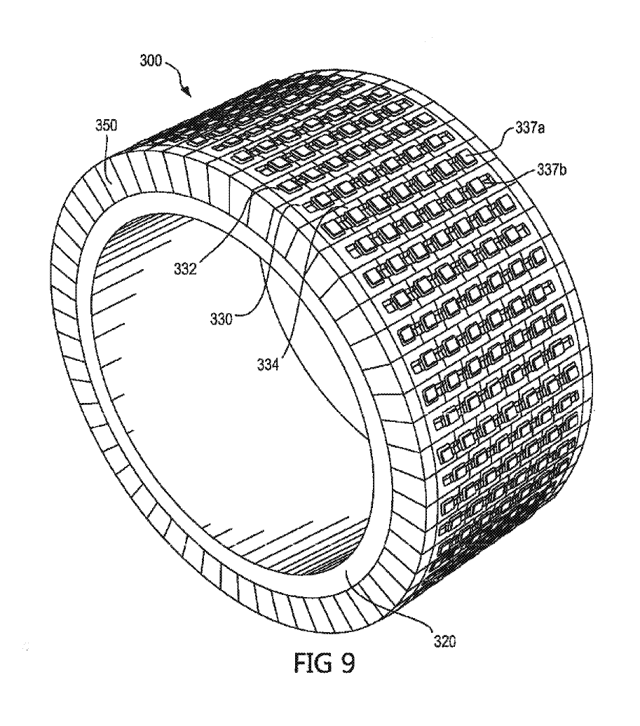

Unlike the roller assembly 100 described above, the present embodiment uses multiple surface segments 230, 234 across the length of the hub 220, which are arranged in axial rows. The number of segments 230, 234 in each row can vary depending on the shape of the segments, the application for the roller, and the length of the roller. For example, in the embodiment shown in FIG. 5A, there are nine surface segments 230, 234 in each row. Other arrangements would also be possible depending on the size of the segments 230, 234 and the length of the roller assembly 200. The number of segments can also vary between rows. For example, in the embodiment shown in FIG. 9, there are alternating rows of six and seven surface segments 330, 332, 334 per row. Other arrangements are also contemplated, particularly where an application calls for segments of varying sizes to be used.

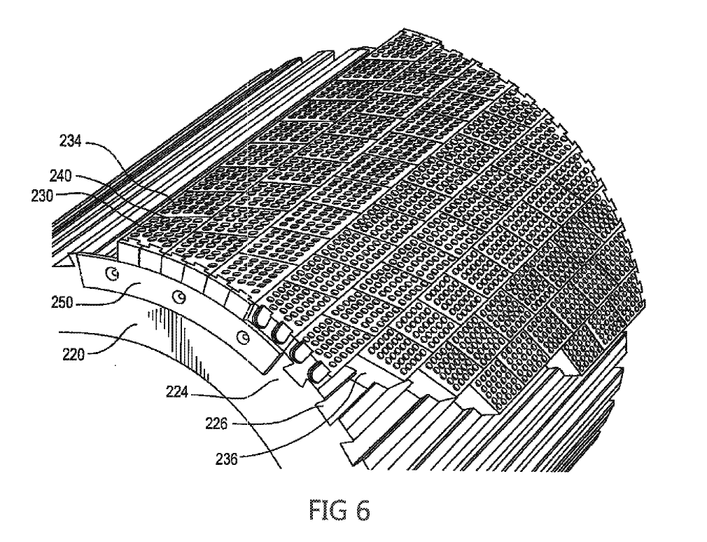

FIG. 6 provides an enlarged view of the roller assembly 200 of FIGS. 5A-5C in a partially disassembled state. In this embodiment, the engagement structures 226 on the outer surface 225 of the hub 220 are a series of channels having a consistent profile, which are substantially parallel and extend across the width of the hub 220. Each of the surface segments 230, 234 are provided with a corresponding engagement structure 236 on their respective inner surfaces, in this case a projection having a corresponding profile that slidably engages with the engagement structure 226 on the hub 220.

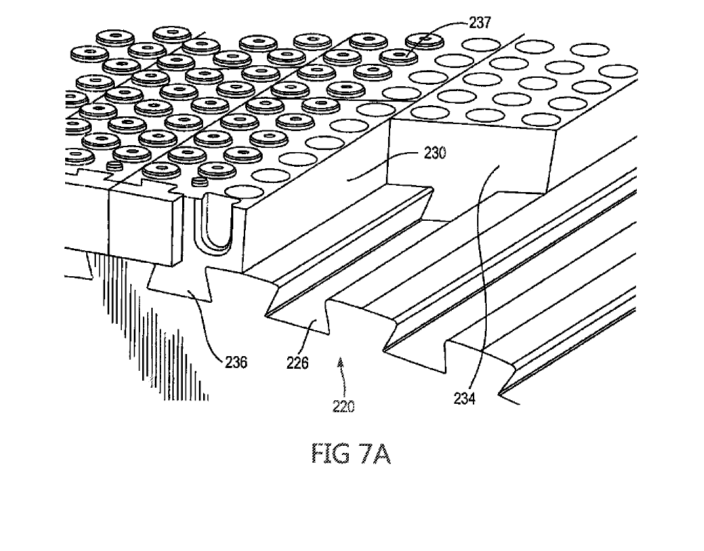

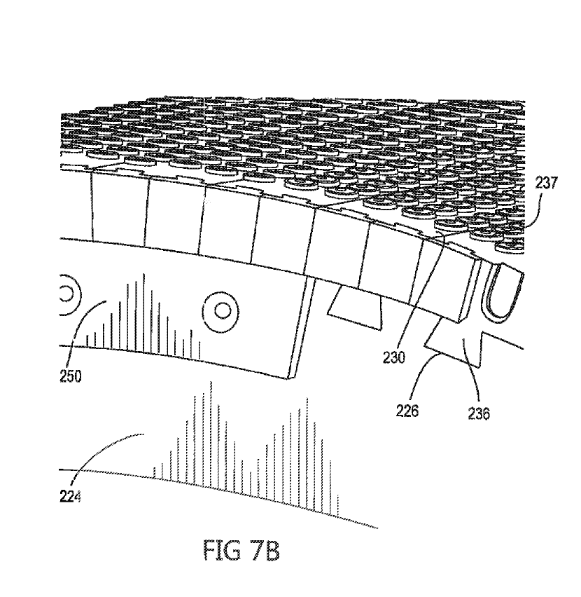

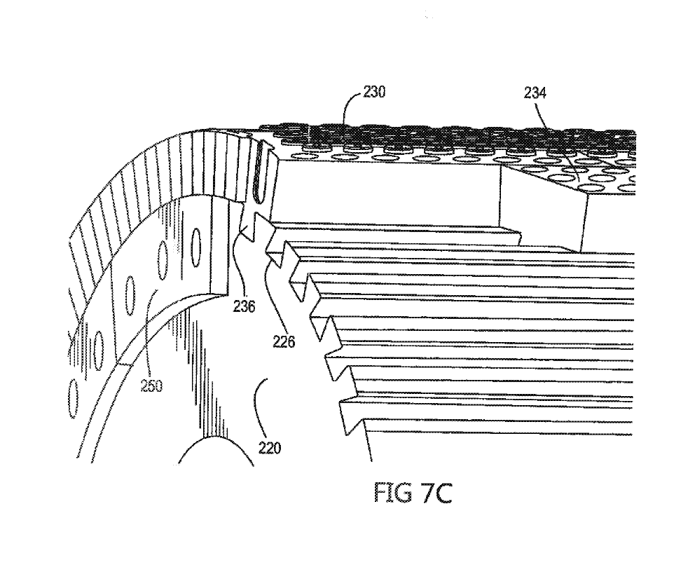

As can be seen in FIGS. 6-7C, the engagement structures 226, 236 in this embodiment are dovetailed so as to create an interlocking relationship between the surface segments 230, 234 and the hub 220. In this embodiment, the sides and bottom of the male engagement member 236 subtend an angle of between 70 and 75 degrees, so as to generate a dovetail profile when viewed in cross-section. In some embodiments, the angle is the same on both sides of the engagement members 226, 236. In other embodiments, the angles are different so as to enforce directionality on the sliding engagement.

The resulting arrangement permits the male engagement member 236 on the surface segments 230, 234 to be slid into the female engagement structure 226 on the hub 220 from an opposing end 224 of the hub 220. Once slidably engaged with one another in this interlocking manner, the engagement structures 226, 236 prevent movement of the surface segments 230, 234 in the radial direction (e.g. see FIG. 7A).

In some embodiments, sliding engagement is aided by a clearance between the engagement structures 226, 236, such as 1 mm, 0.5 mm, or 0.25 mm. Other suitable clearances would be apparent to the person of skill in the art. Although a frictional fit may be sufficient in some applications, glue may also be added to the engagement structures 226, 236 to further secure the surface segments 230, 234 and/or to prevent the entry of milled material therebetween. The use of heat-sensitive glues for this purpose may allow for better release of the surface segments 230, 234 from the engagement structures 226 when the roller assembly 200 is reconditioned.

Other embodiments of the engagement structures 226, 236 are also contemplated in which the male and female relationship of the engagement structures 226,236 is reversed. Other forms of interlocking relationship between the engagement structures 226, 236 may also be used as appropriate to restrict radial movement of the surface segments 230, 234, such as T-shaped profiles, ball and socket profiles, head and stalk profiles, or other interlocking profiles. In some embodiments, the engagement structures 226 on the outer surface 225 of the hub 220 may not be parallel to the central axis of the roller assembly 200, such that the surface segments 230, 234 are arranged at an angle across the working surface of the roller assembly 200.

As seen in FIG. 7B, the surface segments 230, 234 may be secured in the axial direction using retention structures 250, in this case a plurality of annular plates attached to an end face 224 of the hub that engages the outermost surface segment 230. Once attached to a full row of surface segments 230, 234 in this manner, the retention structure 250 in this embodiment prevents lateral movement of the surface segments 230, 234 in the axial direction by blocking the exit of the male engagement member 236 from the corresponding female engagement member 226 on the hub 220.

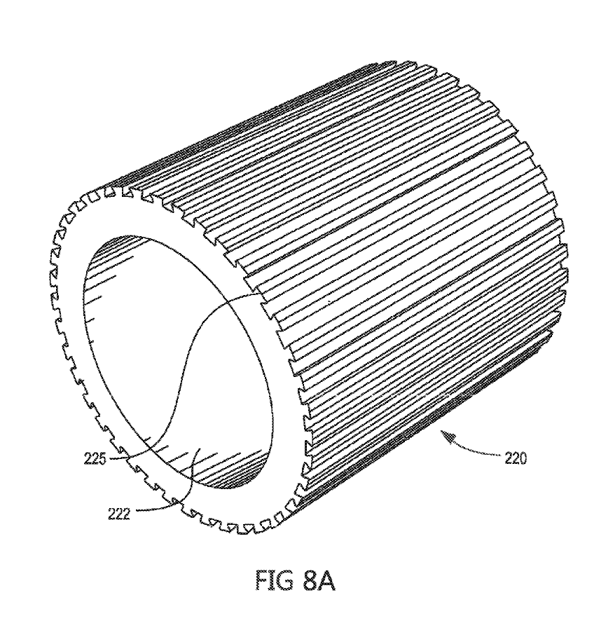

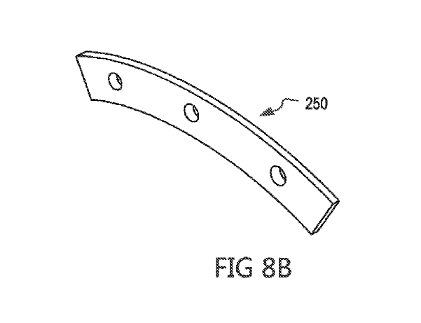

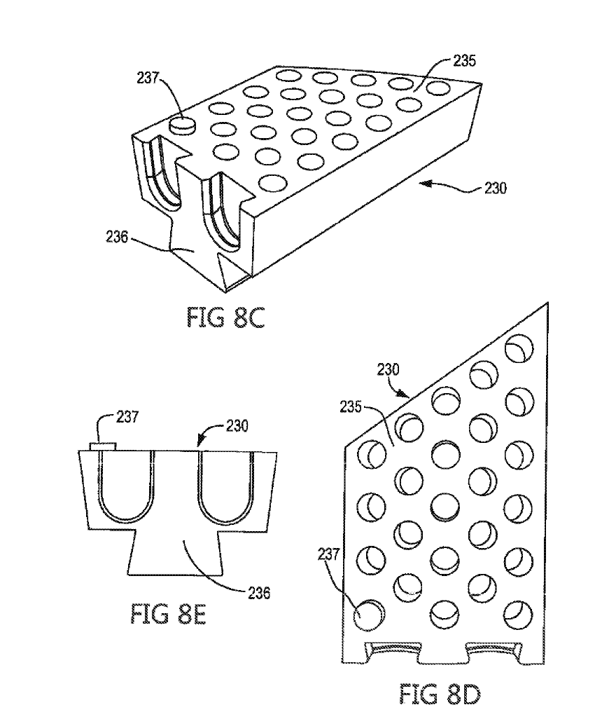

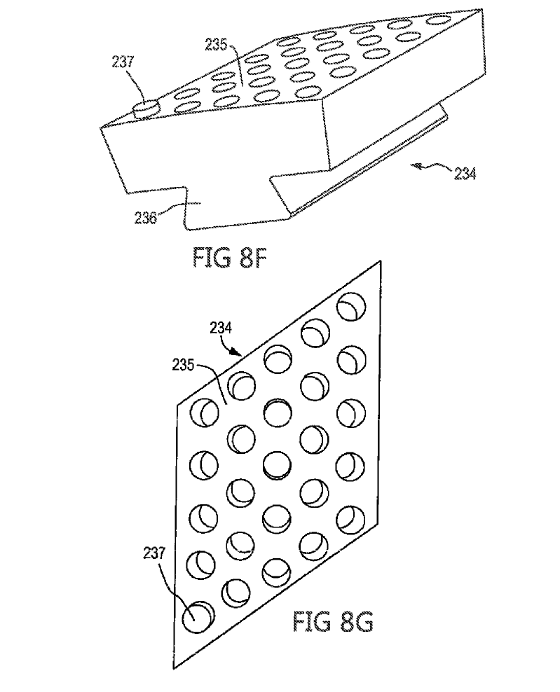

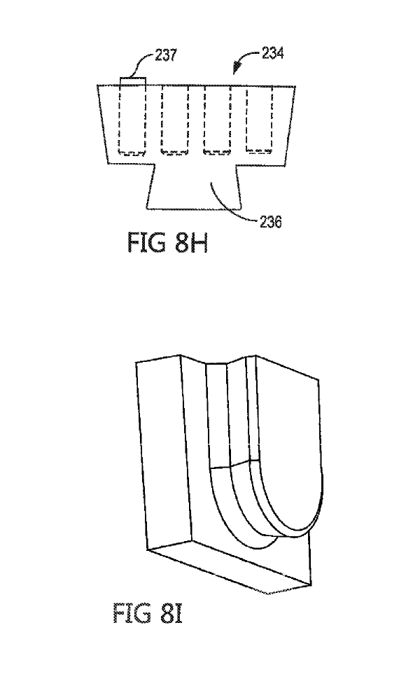

In the embodiment shown in FIGS. 5-8, the retention structure 250 is provided as a series of annular plates (see in particular, FIG. 8B), however, a single circular annular plate is also contemplated as an alternative retention structure 250. Similarly, it may be possible in some embodiments to use a series of bolts or other fasteners to secure the surface segments 230, 234 to the hub 220 in a manner akin to roller assembly 100 above, with or without the use of sliding engagement between the hub 220 and the surface segments 230, 234. Where sliding engagement is used, the outermost surface segments 230 in a row may be bolted to the hub 220 in order to secure a full row of surface segments 230, 234 against movement along the engagement structure 226.

In the embodiment shown in FIGS. 5A-8I, the surface segments 230, 234 are parallelogram-shaped (See in particular FIGS. 5C, 8D, and 8G), with truncated shapes provided at the end of each row to provide a straight edge at the end face 224 of the roller 200. Thus, the working surface in this embodiment is provided by a geometric pattern of surface segments 230, 234. Various other geometric patterns are also contemplated, such as squares, rectangles, parallelograms, or combinations thereof. The use of geometric patterns across the outer surface 225 of the hub 220 thereby permits greater modularity when replacing worn or broken surface segments 230, 234 on the roller assembly 200. Where appropriate, a gap 240 can be provided between adjacent surface segments 230, 234 to reduce wear in the manner described for roller assembly 100 above.

In addition, the specific geometric pattern used in this embodiment orients the gaps 240 between adjacent surface segments 230, 234 at an oblique angle relative to the direction of rotation. For the embodiment shown in FIGS. 5A-8I, the angle is less than 90 degrees, preferably less than 60 degrees and more preferably between 55 and 45 degrees. In this embodiment, surface segments 230, 234 in adjacent rows are also staggered relative to one another, much like bricks in a brick wall. Either of these features may, in some applications, distribute torsional forces applied to the working surface across a greater surface area, which in turn may extend the life of the roller assembly 200.

As seen in FIG. 7A, the surface features 237 of the embodiment shown in FIGS. 5A-8I are tungsten carbide studs of a similar type described above, which are disposed on the outer surface 235 of the surface segments 230, 234. Various other surface features 237 are also contemplated (see Example 1, above) depending on the application for the roller assembly 200.

In this embodiment, edge reinforcements (FIG. 8I) are provided on the surface segments 230 located at the opposing faces 224 of the hub 220, to reduce wear at the edges of the roller assembly 200. As seen in FIGS. 7A and 8I, the edge reinforcements in this embodiment engage the surface segments 230 via U-shaped dovetails.

In operation, a roller assembly 200 according to the embodiment shown in FIGS. 5A-8I may be used in the conventional manner, as described above for roller assembly 100. When the roller assembly 200 reaches the end of its lifespan, it can be reconditioned by replacing one or more worn surface segments 230, 234 on the hub 220 with new surface segments 230, 234. The replacement of one or more surface segments 230, 234 in turn provides a new working surface for the roller assembly 200, and where applicable, new surface features 237. This allows for reconditioning of surface segments 230, 234 rather than the entire roller assembly 200.

When the reinforced roller 200 shown in FIG. 5A reaches the end of its lifespan, it can be reconditioned by:
a) removing the retention structure 250 (in this case, an annular plate) from one or both ends of the roller assembly 200;
b) sliding the surface segments 230, 234 along the engagement structures 226 (in this case, channels) on the hub 220 past the end face 224 thereof;
c) aligning replacement surface segments 230, 234 with the engagement structure 226 of the hub 220;
d) sliding the surface segments 230, 234 on to the engagement structure 226 of the hub 220 from an end face 224 thereof; and
e) replacing the retention structure 250 to secure the surface segments 230, 232 against movement along the engagement structure 226.

In embodiments where the surface segments 230, 232 or other components have been glued in place, the roller assembly 200, or the component being removed, may be heated to destroy the glue. Hammering may also be required to slide the surface segments on or off of the axial rows 112, 212, particularly if the roller 100, 200 has been fouled with dirt or ground material during its operation. In embodiments where the surface segments are bolted in place, the surface segments 230, 232 may first need to be unfastened from the hub 220 before being slid out of the engagement structure 226.

### Example 3

### Segmented Roller with Slide-on Surface Segments

FIG. 9 provides a roller assembly 300 in accordance with yet another embodiment of the present invention.

As with the other example embodiments, the roller assembly 300 is in general terms a rotatable cylindrical member with a working surface for grinding, shredding, rolling, or other uses. In this embodiment, the roller assembly 300 has a central hub 320 for mounting to a shaft 110, in this case at a central aperture 322 in the manner described for roller assembly 100 above. The hub 320 has an outer surface 325 to which a plurality of surface segments 330, 332, 334 are mounted. The surface segments 330, 332, 334 form some or all of the working surface of the roller assembly 300. These features have similar function to the corresponding features discussed above for roller assembly 100 and so similar reference numerals in the ‘300’ series have been used to illustrate features having similar functions in this embodiment.

Similar to the roller assembly 200 shown in FIGS. 5A-8I, described above, the roller assembly 300 in FIG. 9 has multiple surface segments 330, 332, 334 across the length of the hub 320, in this case in rows substantially parallel to the central axis of the hub 320. As discussed above, the number of rows on the outer surface 325 of the hub 320 or the number of segments 330, 332, 334 in each row can vary depending on the intended length and diameter of the desired roller assembly 300. An engagement structure 336 (in this case a dovetailed projection) is also provided on the inner surface of the surface segments 330, 332, 334 which slidably engages with an engagement structure 226 (in this case a dovetailed channel) on the surface 325 of the hub 320.

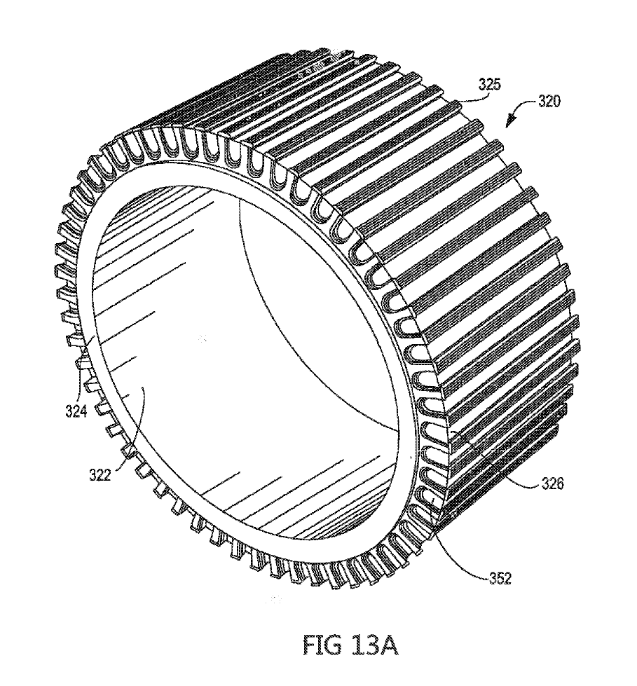

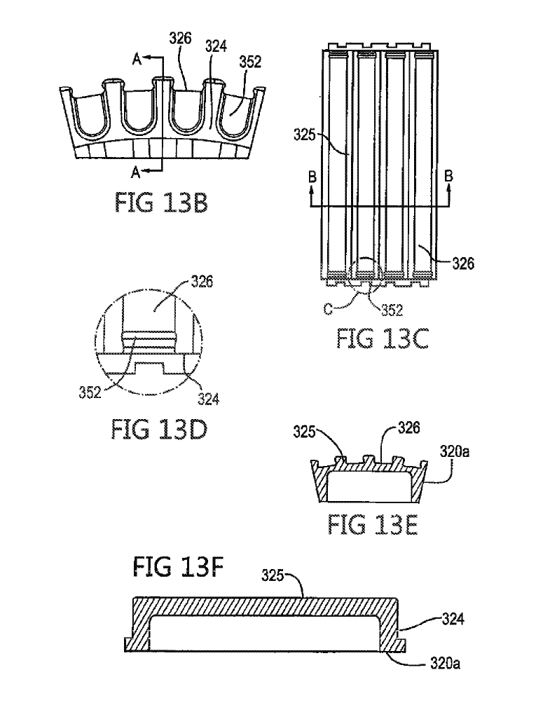

FIG. 13A depicts the hub 320 of FIG. 9 in isolation. In this embodiment, the engagement structures 326 on the hub 320 are a series of channels having a consistent profile and extending across the width of the hub 320. In general terms, the engagement structures 326 are similar to the engagement structures 226 of the roller assembly 200 shown in FIGS. 5A-8I and function in an analogous manner.

As can be best seen in FIG. 13E, the hub 320 in this embodiment comprises two layers. An outer layer 320a provides the outer surface 325 of the hub 320, including the engagement structures 326. An inner layer (not shown) is then mated to the outer layer 320a by conventional means, such as gluing, heat shrinking, or friction fit. In some embodiments, the outer layer 320a is divided into segments, to simplify its removal (see for example, FIGS. 13C-13F). The resulting multi-layer hub 320 allows for the replacement of worn engagement structures 326 on the hub 320 without needing to replace the entire hub 320.

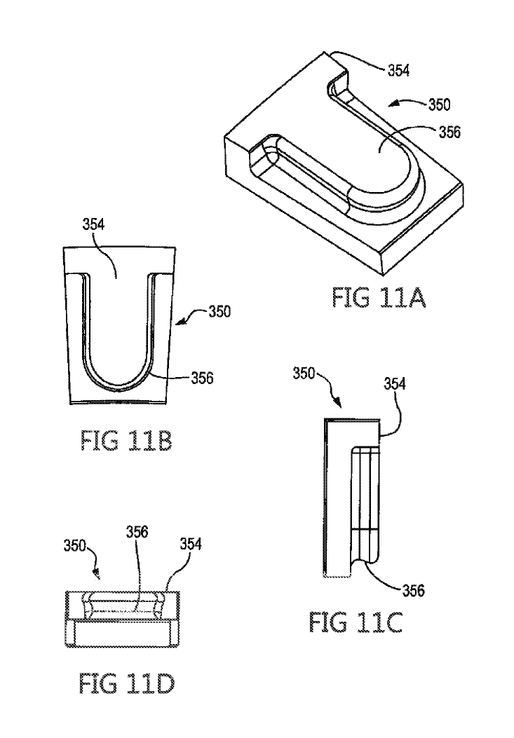

In the embodiment shown in FIGS. 13A-13E, a U-shaped dovetail 352 is provided on the end face 324 of the hub 320 in alignment with the engagement structure 326, which serves as an attachment point for a retention structure 350. In this embodiment, the retention structure 350 is an edge protector constructed from tungsten carbide or other hardened materials. FIGS. 11A-11D provide enlarged views of one such edge protector. In this embodiment, the edge protector is constructed from a hardened material such as tungsten carbide and serves to reinforce the edge of the roller assembly 300 (see FIG. 9).

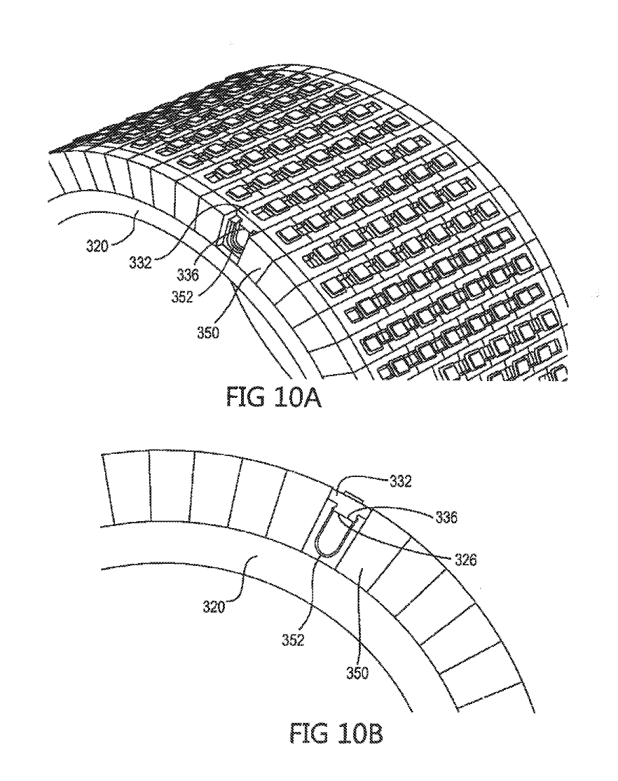

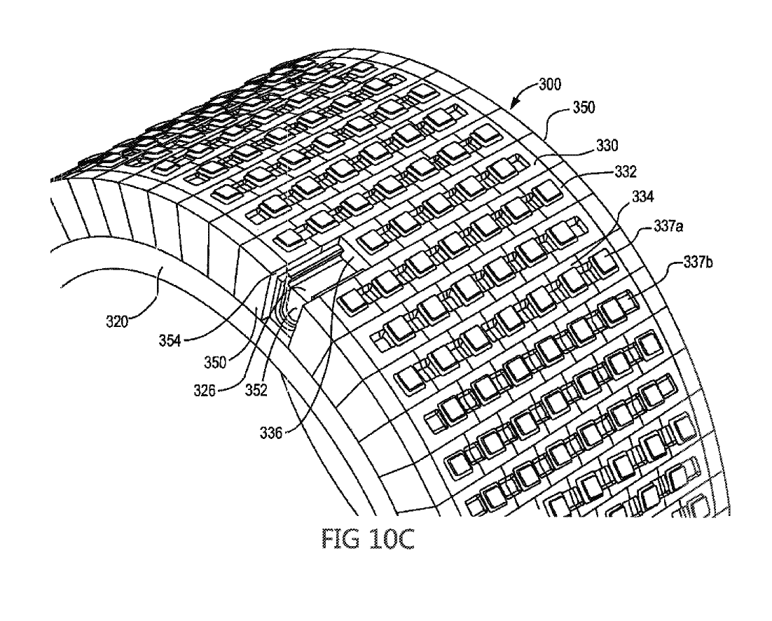

FIGS. 10A-10C provide enlarged views of the roller assembly 300 of FIG. 9 in a partially disassembled state. In this embodiment, the edge protector also serves as a retention structure 350 to secure the surface segments 330, 332, 334 on the outer surface 325 of the hub 320. In this embodiment, a projection 356 on the edge protector slidably engages the U-shaped dovetail 352 on the end face 324 of the hub 320. The corresponding profiles of the dovetail 352 and projection 356 create an interlocking relationship there between. Engagement between the projection 356, or in some cases a shoulder 354, of the retention structure 350 and a surface segment 330, 332 positioned at the end of a full row secures the surface segments 330, 332, 334 against movement in the axial direction by blocking the exit of the projection 336 from the channel 226. In some applications, the retention structures can be secured by frictional fitting. In other applications, glues or fasteners may be used to secure the retention member 350.

In alternative embodiments, the edge protection function and the retention function can be mediated by separate structures. Similarly, the male and female roles in the interlocking relationship between the retention member 350 and the hub 320 can be reversed. Various other forms of interlocking relationship can also be employed as appropriate. Moreover, in some embodiments, the connection between the end face 324 of the hub 320 is indirect. In such embodiments, the indirect connection can be mediated by a retainer plate fastened to the end face 324 of the hub 320, with the retention structure 350 slidably engaging with the retainer plate rather than the end face 324 of the hub 320 itself. As discussed for the roller assembly 200 shown in FIG. 5A, it may also be possible to use bolts as a retention structure, by fastening the outermost surface segments 330, 332 at the end of each row to the hub 320, so as to prevent movement of a full row of surface segments 330, 332, 334 along the engagement structure 326.

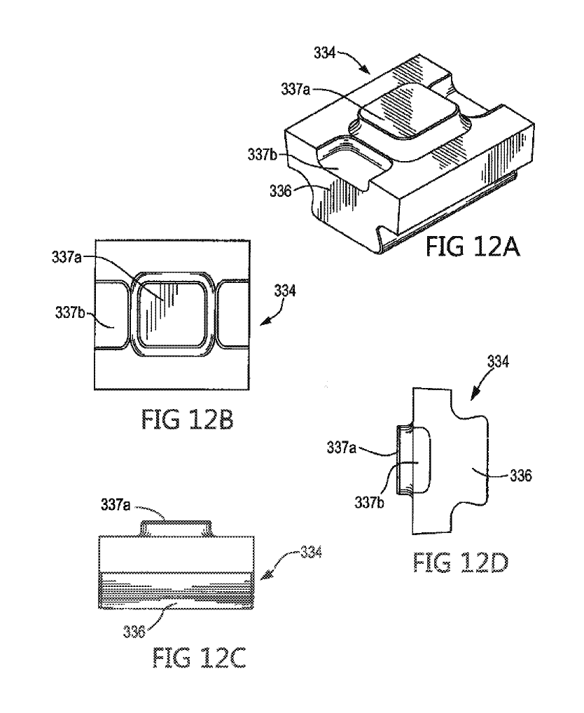

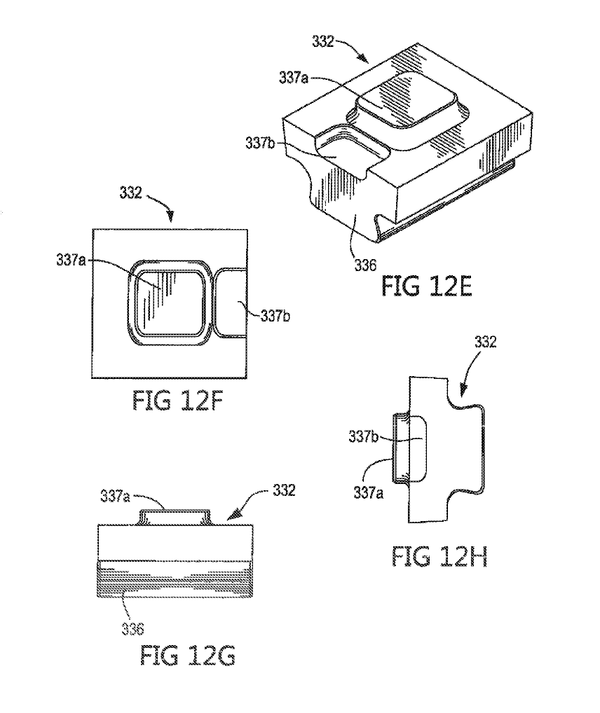

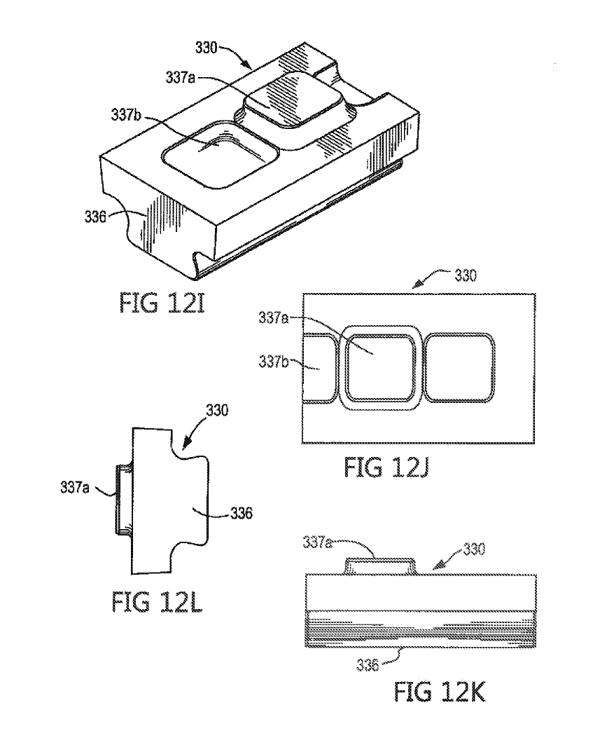

In the embodiment shown in FIG. 9, the surface segments 330, 332, 334 are arranged in a geometric pattern of square segments 330, 332, with rectangular segments 334 positioned at the end of each row to provide a continuous straight edge near the end face 324 of the hub 320. Enlarged views of surface segments 330, 332, and 334 are provided in FIGS. 12A-12L. As can be seen in FIG. 9, the pattern used on the roller assembly 300 results in a staggered ‘brick-like’ pattern, in which the gaps 340 between adjacent surface segments 330, 332, 334 do not align with the direction of rotation. As discussed for the roller assembly 200 above, this staggered arrangement may distribute forces at the working surface of the roller during use, which may in turn extend the life of the roller assembly 300.

As seen in FIGS. 12A-12L, the surface segments 330, 332, 334 in this embodiment also include surface features 337a, 337b. In this case, the surface features are teeth 337a and depressions 337b. As seen in FIGS. 9, 12A, 12E, and 12I, the depressions 337b disposed on adjacent surface segments 330, 332, 334 can cooperate with one another to form a single surface feature, in this case a larger depression. In other embodiments, the teeth may be similarly formed from more than one surface segment 330, 332, 334. As with the roller 100 described above, a variety of different types of surface segment are contemplated.

In this embodiment, the offset pattern of teeth 337a and depressions 337b provided at the working surface of the roller assembly 300 allows for applications in which two roller assemblies 300 are used, with the teeth 337a of one roller assembly 300 aligned with the depressions 337b of the other roller assembly 300, in an intermeshed relationship.

In operation, a roller assembly 300 according to the embodiment shown in FIG. 9 may be used in the conventional manner, as described above for roller assembly 100 and 200. When the roller assembly 300 reaches the end of its lifespan, it can be reconditioned by replacing one or more worn surface segments 330, 332, 334 on the hub 320 with replacement surface segments.

The replacement of one or more surface segments 330 in turn provides a new working surface for the roller assembly 300, and where applicable, new surface features 337. This allows for reconditioning of the surface segments 330, 332, 334 rather than the entire roller assembly 100.

When the reinforced roller 300 shown in FIG. 5A reaches the end of its lifespan, it can be reconditioned by:
a) removing the retention structure 350 (in this case, an edge reinforcement engaging a surface segment) from one or both ends of the roller assembly 300;
b) sliding the surface segments 330, 334 along the engagement structures 326 (in this case, channels) on the hub 320 past the end face 224 thereof;
c) aligning replacement surface segments 330, 332, 334 with the engagement structure 326 of the hub 320;
d) sliding the surface segments 330, 332, 334 on to the engagement structure 326 of the hub 320 from an end face 324 thereof; and
e) replacing the retention structure 350 to secure the surface segments 330, 332, 334 against movement along the engagement structure 326.

As discussed for the roller assembly 200 in FIG. 5A, some or all of the roller assembly 200 can be heated to release a glue, if appropriate. Hammering may also be required and in some embodiments, and one or more the surface segments 330, 332, 334 may be bolted in place, as described above. In embodiments where the hub 320 comprises an inner layer (not shown) and an outer layer 320a, a further step in remanufacture may be the replacement of the outer layer 320a of the hub 320, before attaching replacement surface segments 330, 332, 334.

The embodiments of the present disclosure are intended to be examples only. Those of skill in the art may effect alterations, modifications and variations to the particular embodiments without departing from the intended scope of the present application.

In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. The subject matter described herein and in the recited claims intends to cover and embrace all suitable changes in technology.

1-43. (canceled)

44. A roller assembly having a working surface for crushing, grinding, or otherwise contacting a material, the roller assembly comprising:
a hub configured for mounting to a shaft, said hub rotating about a central axis and having to opposing faces, a length parallel to the central axis, and an exterior surface;
one or more engagement structures disposed on the exterior surface of the hub, preferably along the length of the hub; and
a plurality of replaceable surface segments configured for releasably attaching to said one or more engagement structures, each of the plurality of surface segments having an inner surface configured to engage at least one engagement structure and an outer surface opposed to the inner surface;
wherein the working surface comprises the outer surface of at least one of the plurality of surface segments; and
wherein the inner surface of the plurality of replaceable surface segments slidably engages the engagement structures in an interlocking relationship.

45. The assembly of claim 44, wherein the engagement structures situate the surface segments at predetermined positions on the exterior surface of the hub, preferably with a gap between the outer surfaces of adjacent surface segments, even more preferably wherein the gap is less than 1 mm or less than 0.25 mm.

46. The assembly of claim 44, wherein the interlocking relationship is selected from the group consisting of dovetail profiles, T-shape profiles, ball and socket profiles, head and stalk profiles, and a U-shaped dovetail profiles.

47. The assembly of claim 44, further comprising an annular plate disposed on at least one of the opposing faces of the hub, the annular plate engaging at least one of the plurality of surface segments to prevent movement thereof.

48. The assembly of claim 44, further comprising an edge reinforcement which engages, preferably by sliding engagement:
at least one of the opposing faces of the hub; or
a retainer plate fastened to at least one of the opposing faces of the hub;
the edge reinforcement also engaging at least one of the plurality of surface segments to prevent movement thereof.

49. The assembly of claim 48, wherein the sliding engagement of the edge reinforcement is mediated by a mortise and tenon relationship, preferably a dovetail, and more preferably a U-shaped dovetail.

50. The assembly of claim 44, wherein the inner surface of the plurality of surface segments comprises a projection or channel that is between about one-quarter to one-half the width of the surface segment, preferably about one third the width of the surface segment.

51. The assembly of claim 44, wherein:
the plurality of surface segments are arranged on the outer surface of the hub in at least two adjacent rows extending between the opposing faces of the hub; and
one or more surface segments in the first adjacent row are staggered with respect to one or more surface segments in the second adjacent row.

52. The assembly of claim 51, wherein the plurality of surface segments include surface segments which are substantially square, rectangular, triangular, parallelogram-shaped, or a combination thereof, preferably in a repeating geometric pattern.

53. The assembly of claim 44, wherein:
at least two of the plurality of surface segments are arranged on the outer surface of the hub in at least one row extending between the opposing faces of the hub; and
two or more adjacent surface segments in the at least one row meet at an oblique angle relative to the direction of rotation, preferably less than 90 degrees, less than 60 degrees, or between 55 and 45 degrees.

54. The assembly of claim 53, wherein the plurality of surface segments include surface segments which are substantially square, rectangular, triangular, parallelogram-shaped, or a combination thereof, preferably in a repeating geometric pattern.

55. The assembly of claim 44, wherein the hub comprises an inner layer configured for mounting to the shaft and an outer layer, preferably segmented, comprising the exterior surface upon which the engagement structures are disposed.

56. A replaceable surface segment for an assembly according to claim 44.

57. A method of reconditioning a roller assembly, the method comprising:
removing a retention structure from the roller assembly to permit one or more worn surface segments to slide along an outer surface of the hub of the roller, the hub rotatable about a central axis;
removing one or more worn surface segments from an outer surface of a hub of the roller by sliding the one or more worn surface segments along an engagement structure disposed on the outer surface of the hub to a peripheral edge of the hub;
engaging an inner surface of one or more replacement surface segments with an engagement structure disposed on the outer surface of the hub; and
securing the one or more replacement surface segments to the outer surface of the roller by replacing the retention structure.

58. The method of claim 57, further comprising the step of:
aligning the one or more replacement surface segments on the engagement structure, so as to create a predetermined gap between adjacent surface segments.

59. The method of claim 57, wherein:
the retention structure comprises an annular plate connected to an end face of the huh, at the intersection of the engagement structure and the peripheral edge of the hub; and
the step of removing the retention structure comprises disconnecting the annular plate from the peripheral edge of the hub.

60. The method of claim 57, wherein:
the retention structure comprises an edge reinforcement slidably engaged with an end face of the hub or a retainer plate fastened to an end face of the hub, at the intersection of the engagement structure and the peripheral edge of the hub; and
the step of removing the retention structure comprises sliding the edge reinforcement away from the hub.

61. The method of claim 57, wherein the step of engaging the inner surface of one or more replacement surface segments comprises aligning a first interlocking feature on the inner surface of the one more replacement surface segments with a second interlocking feature on the engagement structure.

62. The method of claim 57, further comprising heating one or more portions of the roller assembly to destroy any glue applied thereto.

63. The method of claim 57, wherein:
the hub comprises an inner layer configured for mounting to a shaft and an outer layer comprising the exterior surface upon which the engagement structures are disposed; and
the method comprises the further step of replacing the outer layer of the hub before engaging the inner surface of the one or more replacement surface segments.
